(19) United States
(12) Patent Application Publication
(10) Pub. No.: US 2015/0314398 A1
(43) Pub. Date: Nov. 5, 2015

(54) METHOD AND SYSTEM FOR ALLOYED STRIP WELDING AND CLADDING AND ALLOYED STRIP CONSUMABLE

(71) Applicant: LINCOLN GLOBAL, INC., CITY OF INDUSTRY, CA (US)

(72) Inventors: Steven R. Peters, Huntsburg, OH (US); George C. Willard, JR., Willoughby, OH (US); John R. Procario, Strongville, OH (US)

(21) Appl. No.: 14/678,919

(22) Filed: Apr. 3, 2015

Related U.S. Application Data
(60) Provisional application No. 61/977,235, filed on Apr. 9, 2014.

(51) Int. Cl. B23K 35/02; B23K 11/00

(52) U.S. Cl. CPC B23K 35/0266; B23K 35/0277; B23K 11/0013

(57) ABSTRACT

The invention provided is a system and method for welding or cladding using a strip electrode which is capable of delivering a desired chemistry, where the strip electrode contains an alloying or flux material. In embodiments, the strip electrode has at least two bulge portions separated by a web portion where the bulge portions have a larger thickness than the web portions. Other embodiments deliver each of a strip electrode and a cored electrode to the same puddle, while the electrodes make contact with each other before the puddle and share the deposition current.

### PRIORITY AND INCORPORATION BY REFERENCE

The present application claims priority to U.S. Provisional Patent Application No. 61/977,235, which is incorporated herein by reference in its entirety.

### TECHNICAL FIELD

Devices, systems, and methods consistent with the invention relate to welding and cladding, and more specifically to devices, systems and methods for welding and cladding with an alloyed strip consumable, and a consumable for the same.

### BACKGROUND

In many welding and cladding operations, strip electrodes are used. These electrodes generally have a rectangular cross-section as compared to the traditional circular cross-section electrodes. Strip electrodes have the advantage of being able to cover a large area in a single pass. However, a significant disadvantage to the use of strip electrodes is their limited use in many alloying applications. That is, for most applications requiring a specific alloying for the deposit, strip electrodes cannot be used because the strip material does not have the desired chemistry. Further, unlike with circular electrodes, there are no known methods for adding an alloying powder or flux with strip electrodes. Thus, the use of strip electrodes for welding and cladding applications is greatly limited by the strip electrode composition limitations. Moreover, it is not possible to add hardfacing materials when using traditional strip electrode consumables and processes.

Further limitations and disadvantages of conventional, traditional, and proposed approaches will become apparent to one of skill in the art, through comparison of such approaches with embodiments of the present invention as set forth in the remainder of the present application with reference to the drawings.

### BRIEF SUMMARY OF THE INVENTION

An exemplary embodiment of the present invention is a system and method for welding or cladding using a strip electrode which is capable of delivering a desired chemistry, where the strip electrode contains an alloying or flux material.

### BRIEF DESCRIPTION OF THE DRAWINGS

The above and/or other aspects of the invention will be more apparent by describing in detail exemplary embodiments of the invention with reference to the accompanying drawings, in which:

FIG. 1 is a diagrammatical representation of an exemplary welding/cladding system in accordance with an embodiment of the present invention;

FIGS. 2A-2C are diagrammatical representations of cross-sections of exemplary strip electrodes of the present invention;

FIGS. 3A-3C are diagrammatical representations of additional strip electrode cross-sections in accordance with exemplary embodiments of the present invention;

FIGS. 4A-4C are diagrammatical representations of further strip electrode cross-sections in accordance with exemplary embodiments of the present invention;

FIG. 5 is a diagrammatical representation of another exemplary system of the present invention to be used for cladding or welding; and

FIGS. 6A-6B are diagrammatical representations of exemplary cross-sections of contact tips that can be used with embodiments of the present invention.

### DETAILED DESCRIPTION

Reference will now be made in detail to various and alternative exemplary embodiments and to the accompanying drawings, with like numerals representing substantially identical structural elements. Each example is provided by way of explanation, and not as a limitation. In fact, it will be apparent to those skilled in the art that modifications and variations can be made without departing from the scope or spirit of the disclosure and claims. For instance, features illustrated or described as part of one embodiment may be used on another embodiment to yield a still further embodiment. Thus, it is intended that the present disclosure includes modifications and variations as come within the scope of the appended claims and their equivalents.

The present disclosure is generally directed to cladding and welding operations which use strip electrodes. It should be noted that for purposes of brevity of clarity, the following discussion will be directed to exemplary embodiments of the present invention which are primarily directed to using a deposition process employing an arc. However, embodiments of the present invention are not limited in this regard and embodiments of the present invention can be used in welding and cladding operations which use an electroslag process without departing from the spirit or scope of the present invention.

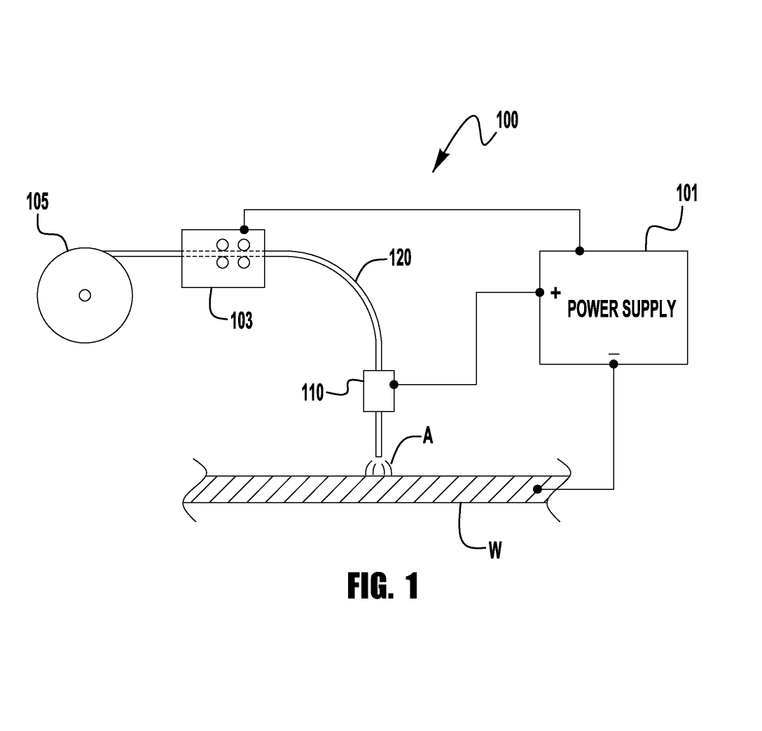

Turning now to FIG. 1, an exemplary system 100 is depicted. The system 100 is constructed similar to existing cladding/welding systems which utilize strip electrodes on various workpieces W. That is, the system 100 uses a power supply 101 to deliver a current signal to a contact tip 110 which provides the current to the electrode 120. In an arc process an arc A is generated (no arc is created in an electroslag welding operation). The electrode is delivered to the weld/clad operation via a feeding device 103, which typically communicates with the power supply 101. The electrode 120 is provided to the wire feeder 103 from source 105 (such as a reel). Not shown in FIG. 1 is a flux deposition system. Because a submerged arc welding method (SAW) is often used with strip electrodes a flux is deposited into the workpiece W during the operation. For purposes of clarity, the flux deposition system is not shown, but can be constructed consistent with known and available flux deposition systems. Further, the power supply 101 can be constructed and controlled consistent with known power supplies used for welding/cladding with strip electrodes. The operation of such power supplies 101 is generally known and is consistent with known methods and need not be described in detail herein.

As indicated previously, known strip welding/cladding methods are limited in their applications because of the limited uses when alloyed deposits are required. Embodiments of the present invention address these issues by utilizing novel strip electrodes and/or system configurations as described herein.

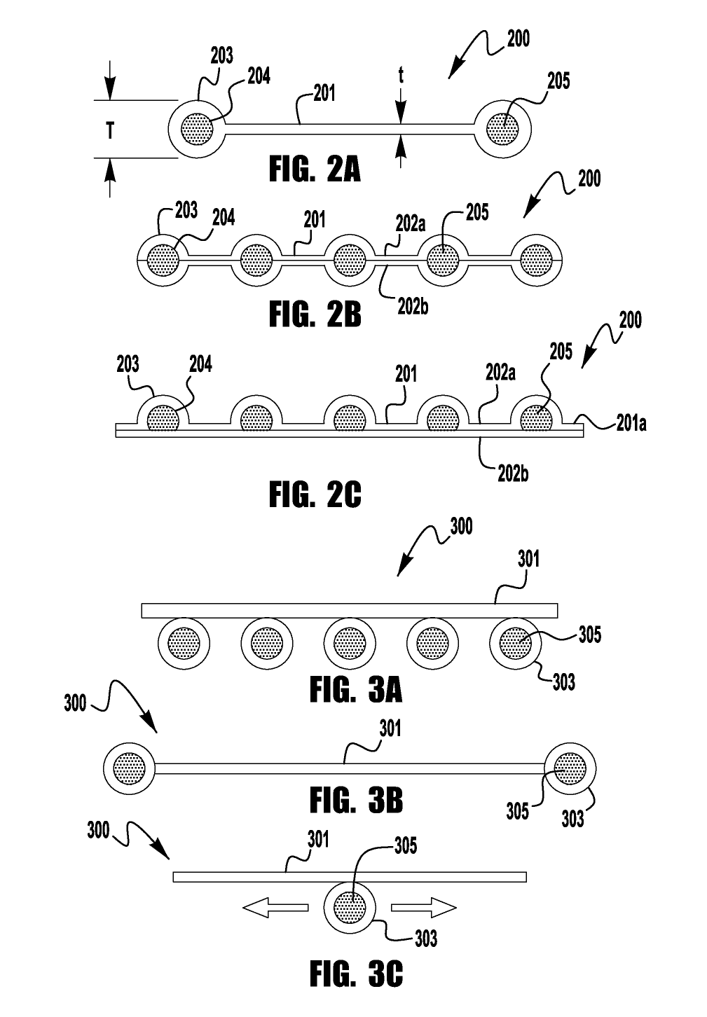

Turning to FIGS. 2A to 2C, a number of exemplary embodiments of strip electrodes 200 are depicted (cross-section is shown). As shown, in each embodiment at least two bulge portions 203 are separated by a web portion 201. Each of the bulge portions 203 have a cavity 204 which contains a flux 205. The flux 205 can have any desired composition to provide the desired weld/clad chemistry after the welding/cladding operation. Specifically, the flux 205 can have a composition which delivers the desired alloying for the deposit. Further, while the figures (and the following discussion) focus on using a flux (granular/powder) in the cavities 204, in other exemplary embodiments a solid core can be placed within the cavities 204 where the solid core 205 would have a different composition than the strip material used for the strip web 201 and bulge portions 203. In exemplary embodiments of the present invention, the strip material used for the electrode 200 is similar to known materials and has a composition similar to known strip electrodes. The flux/solid core 205 has a composition which, when deposited, provides the desired deposit chemistry for the welding or cladding operation. When embodiments of the strip electrode (for example those shown in FIG. 2) are used with the system 100 a weld or cladding deposit can be obtained having a specific chemistry or alloying characteristics—that could not be achieved with known strip welding/cladding methods and systems. Of course, it should be noted that the contact tip 110 orifice should be configured so as to adequately provide current to the strip 200. That is, the contact tip 110 should be configured based on the cross-sectional shape of the strip 200.

As shown in FIG. 2 the web portions 201 of the strip 200 have a thickness t which is less than the overall thickness T of the bulge portions—which allows for the presence of the cavities 204. In exemplary embodiments, the bulge thickness T is in the range of 1.5 to 8 times the thickness t of the web 201. In further exemplary embodiments, the bulge T thickness is in the range of 2 to 5 times the thickness t of the web 201.

The embodiment shown in FIG. 2 A shows two bulge portions 203 positioned on each end of the strip 200. The web portion 201 can be of any desired length to achieve the desired spacing between the bulge portion 203. In other exemplary embodiments, the bulge portions 203 can be internal to the outer ends of the strip 200, such that at least some portion of the web 201 extends outward from the bulge portion 203. Such an embodiment would move the bulge portions closer to each other. As shown in each of FIGS. 2B and 2C other exemplary embodiments of the strip can also be used. For example, FIGS. 2B and 2C show a strip 200 having more than two bulge portions 203 separated by web portions 201. Each of the bulge portions 203 contains a flux/solid core 205 to achieve a desired deposit chemistry. In some exemplary embodiments, each of the flux/solid cores 205 in the bulge portions 203 have the same composition. However, in other exemplary embodiments, the flux/solid cores 205 in the respective bulge portions 203 can have different compositions. For example, in such embodiments, each adjacent bulge portion 203 can have alternating compositions. Such embodiments can provide greater flexibility in the customization of a weld/cladding deposit. For example, in some exemplary embodiments, some of the bulge portions 203 can contain flux material that provides a desired alloying attribute, while other bulge portions contain hard facing materials that are to be deposited. This flexibility cannot be attained with known strip welding/cladding techniques.

Further, as shown in each of FIGS. 2B and 2C the strip 200 can be made up of at least two strip portions 202a and 202b. As shown in FIG. 2B each strip portion is a corrugated strip material such that when the portions 202a and 202b are assembled the cavities 204 are created. FIG. 2C is another exemplary embodiment where the cavities 204 are formed in only one of the strip portions 202a and the other strip portion 202b is a flat portion which closes the cavities 204. The strip portions 202a/202b can be secured to each other via any known methodology, such as spot or tack welding in the web portions 201. Of course, the cavities 204 in the strips 200 can be made via any known methodologies, and embodiments of the present invention are not limited in this regard. Further, embodiments of the present invention are not limited by the overall width of the strip 200. Additionally, as shown in FIG. 2C, the strip 200 can have a web portion 201a that extends outward from the outermost (from the centerline) bulge portions. That is, in some embodiments, bulge portions 203 can be positioned at the outer ends of the strip 200 (FIG. 2B), while in other embodiments a web portion 201a can be positioned at the end of the strip 200 (FIG. 2C). Further, while the embodiments shown in FIGS. 2A through 2C are shown to be symmetrical relative to the centerline of the cross-section of the strip 200, other embodiments need not be symmetrical.

Also, as shown FIGS. 2A through 2C each of the bulge portions 203 in the respective strips 200 have the same shape and size. However, other exemplary embodiments are not limited in this way. For example, in some exemplary embodiments the bulge portions 203 at or near the center of the strip 200 have a different shape and/or larger dimensions than the outer bulge portions 203. In such embodiments, the inner bulge portions 203 can have larger cavities 204 to deposit more flux/solid core 205 at the center of the deposit. Of course, the opposite can also be true depending on the desired performance of a given operation.

FIGS. 3A through 3C depict other exemplary embodiments of the present invention. However, unlike FIGS. 2A through 2C, these embodiments use strip assemblies 300 which are made up of multiple separate components which are in contact with each other as they are deposited into a common puddle on the workpiece W during the welding/cladding process. That is, unlike the FIG. 2 embodiments—in which the strip 200 is an integral unit (which can be made from separate portions—e.g., FIGS. 2B/2C), the FIG. 3 embodiments use separate consumables which are deposited into the same puddle at the same time. For example, as shown in FIG. 3A a metallic strip 301 is deposited into the puddle at the same time as a plurality of cored consumables 303, having a flux or solid core 305 for a desired deposit chemistry. As shown in the Figures the strip 301 is a rectangular cross-section shaped strip, having a longer width than thickness. During deposition the consumables 303 make contact with the strip 301 at or near the deposition into the puddle on the workpiece W. Further, the output current from the power supply 101 is provided to each of the strip 301 and the consumables 303. In some exemplary embodiments each of the consumables 303 and the strip 301 are passed through the same contact tip 110, in which the consumables 303 and the strip 301 are placed in contact with each other. In such embodiments, the output current of the power supply 101 is shared by the strip and consumables 303. Such embodiments can provide the same deposition flexibility discussed above regarding the FIG. 2 embodiments. Specifically, the consumables 303 can be used to achieve the desired alloying and/or deposit chemistry that is not normally achievable with known. In exemplary embodiments, the consumables 303 can be the same, having the same composition and dimensions. However, as with some of the FIG. 2 embodiments, other embodiments can use different consumables 303 to achieve a desired deposit chemistry. Further, the spacing of the consumables 303 can be optimized to achieve the desired deposit chemistry, shape and distribution. In exemplary embodiments, the consumables 303 and the strip 301 can be provided from separate sources through separate feeders to a common contact tip 110 which is configured to provide the current (from the power source 101) to each of the consumables 303 and the strip 301. In other embodiments, separate contact tips 110 can be used for the consumables 303 and strip 301. However, in such embodiments the contact tips 110 share the output current of the power supply 101 and ensure that the consumables 303 and strip 301 make contact with each other and are deposited into the same puddle during the welding/cladding operation. In exemplary embodiments, the contact tips 110 ensure that the consumables and strip make contact with each other prior to their respective deposition into the common puddle on the workpiece W. The consumables 303 can be constructed, and have a composition, similar to known cored consumables, having a circular cross-section, and can have a composition to achieve a desired deposition chemistry.

FIG. 3B is similar to FIG. 3A, except that the consumables 303 are positioned at the ends of the strip 301. Again, in exemplary embodiments the consumables 303 are deposited into the same puddle as the strip 301, and in further exemplary embodiments make contact with the ends of the strip 301 prior to be deposited onto the workpiece.

FIG. 3C is another exemplary embodiment, where the consumable 303 is moved along a surface of the strip 301 during deposition. In such embodiments, a movement mechanism is provided (not shown in FIG. 1) which can move at least one consumable 303 along a surface of the strip 301 so that the consumable 303 is deposited at the proper location. In some embodiments, the consumable 303 can be continuously oscillated along the strip 301, while in other embodiments the consumable is movable such that during different portions or a welding/cladding operation the consumable 303 can be moved to different desired locations. For example, during a first portion of a welding/cladding operation, the consumable 303 can be positioned at a first position (e.g., one end of the strip 301), during a second portion of the welding/cladding operation the consumable can be move to a second position (e.g., center), and during a third portion of the operation, can be moved to a third position (e.g., the other end of the strip 301). In such embodiments, the consumable 303 will use a separate contact tip 110 (to allow for the movement of the consumable 303), but the contact tip 110 will share the output current of the power supply 101 with the contact tip of the strip 110 and the contact tip for the consumable will direct the consumable 303 to the same puddle as the strip 301. As stated above, in exemplary embodiments the consumable 303 will make contact with the strip 301 prior to both being deposited into the puddle. Any known robotic/computer controlled system controller can be used to control the operation of the system 100 described herein. Because such computer controlled/robotic systems are known, they will not be discussed in detail herein.

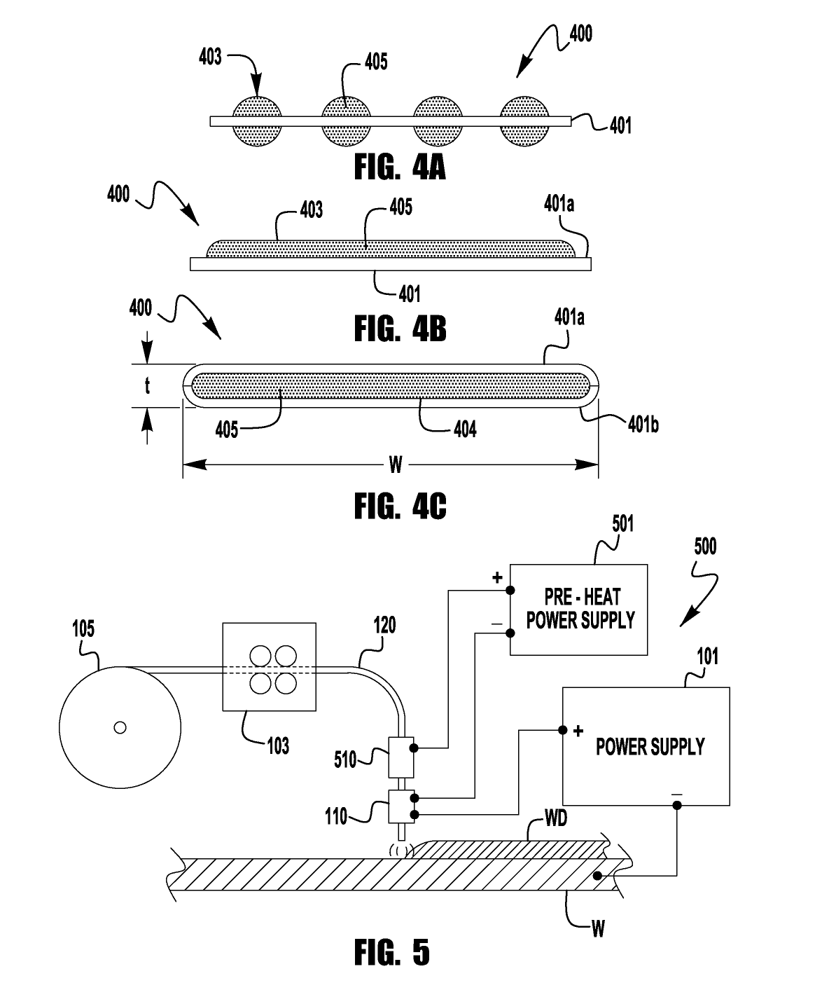

FIG. 4A through 4C depict further exemplary embodiments of a strip consumable 400 contemplated herein. As shown in each of FIGS. 4A and 4B the flux 405 is provided in a bulge portion 403 that is secured to an outer surface of the strip 401. In these embodiments, the flux 405 is secured to an outer surface of the strip—similar to flux adhered to a stick electrode. That is, the flux 405 is not covered by a portion of the strip material (see FIGS. 2 and 3). The flux 405 can be adhered to the strip similar to how flux is adhered to stick electrodes. In FIG. 4A, there are a plurality of bulge portions 403 of flux 403 that can be positioned symmetrically and have the same physical and compositional characteristics. However, as previously discussed, the bulge portions 403 can also have different physical and compositional characteristics, and need not be positioned symmetrically. The embodiment in FIG. 4B has at least one layer 403 of flux 405 positioned on an outer surface of the strip 401. In some exemplary embodiments, a layer 403 can be positioned on both the upper and lower surfaces of the strip 401 (as shown in FIG. 4B). Additionally, as shown in FIG. 4B the strip 401 has an extension portion 401a which extends beyond the ends of the layer 403 so as to allow for sufficient electrical contact between the strip 401 and the contact tip 110 so that the current can be sufficiently transferred.

FIG. 4C depicts another exemplary embodiment of the present invention, where the strip 400 has an elongated cross-sectional shape where a cavity 404 is created by the outer strip material and the flux/solid core 405 is placed within the cavity. In the embodiment shown, the cavity is created by a first 401a and second 401b strip portion which are bonded to each other to create the cavity. In exemplary embodiments, the strip 400 has a cross-section such that its width W to thickness ratio is in the range of 30 to 3. In further exemplary embodiments, the ratio is in the range of 20 to 4, while in further exemplary embodiments the ratio is in the range of 15 to 5.

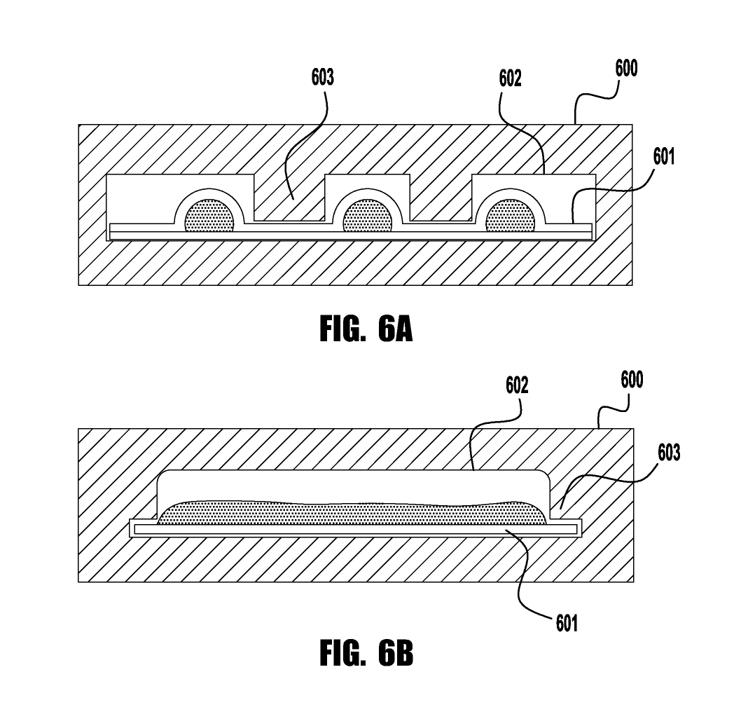

Turning now to FIG. 5, another exemplary system 500 is depicted which can be used with any of the strip electrodes described above, or contemplated herein. Much of the system 500 is similar to the system 100 discussed relative to FIG. 1, and as such those similarities will not be repeated. However, as shown, the system 500 in FIG. 5 also includes a pre-heat power supply 501 which is coupled to a pre-heat contactor 510, through which the strip electrode 120 passes prior to contact tip 110. Because of the novel shapes and configurations of the strip electrodes 120 discussed herein, the strip electrodes 120 may require high levels of current to efficiently deposit the electrode 120 onto the workpiece W, and it may not be practical to have a single power supply provide the needed current. Therefore, in the system 500 a pre-heat power supply 501 provides a pre-heating current (e.g., a constant current signal) which pre-heats the electrode 120 between the pre-heat contactor 510 and the contact tip 110. As shown, the current loop is configured such that either all, or most, of the pre-heat current is removed from the electrode 120 at the contact tip 110. In many applications, this pre-heat will aid in the efficient and proper deposition of the electrode 120. In exemplary embodiments, the pre-heat power supply 501 provides a heating current which heats the strip portion (201, 301, 401) of the electrode to a temperature in the range of 5 to 65% of the melting temperature of the strip portion. In further exemplary embodiments, the temperature is increased to be in the range of 35 to 65% of the melting temp. of the electrode. Thus, the power supply 101 can have better control over the deposition process, particularly when the electrode 120 has a relatively large cross-sectional area. In exemplary embodiments, a heat monitoring system or device can be used to monitor the temperature of the consumable to allow for control of the preheat current. For example, a laser temperature gauge can be used to monitor the temperature of the consumable, at an optimal location (e.g., between tips 510 and 110, or after 110) and the feedback from this sensor can be used to control the current from the power supply 501.

FIGS. 6A and 6B depict the cross-sections of exemplary embodiments of a contact tip 600 that can be used with systems described herein. Of course, it should be noted that the cross-sections depicted in these figures are intended to be exemplary and the present invention is not limited to these embodiments. In FIG. 6A, the tip 600 has a cavity 602 which allows the passage of the electrode 601 such that at least some surface area of the electrode 601 makes contact with the walls of the cavity 602, where the contact surface area is sufficient to adequately transfer the current from the power supply 101 to the electrode 601. As shown, in some embodiments the cavity has protrusion portions 603 which extend into the cavity to make contact with the web portions of the electrode 601. Further, the cavity has sufficient space to allow any existing bulge portions on the electrode 601 to pass through the tip 600. FIG. 6B is similar constructed but has the protrusion portions 603 at the ends of the cavity (as shown) so as to engage with the exposed end portions of the web at shown. Of course, other embodiments can use a combination of FIGS. 6A and 6B where the protrusion portions 603 are placed at the ends of the electrode 601, and in between any bulge portions. In any event, the orifice 602 of the contact tip 600 should be constructed so that a sufficient contact area is provided with the electrode, to allow for the adequate transfer of current.

While the subject matter of the present application has been described with reference to certain embodiments, it will be understood by those skilled in the art that various changes may be made and equivalents may be substituted without departing from the scope of the subject matter. In addition, many modifications may be made to adapt a particular situation or material to the teachings of the claimed subject matter without departing from its scope. Therefore, it is intended that the subject matter not be limited to the particular embodiment disclosed, but that the subject matter will include all embodiments falling within the scope discussed herein.

What is claimed is:

1. A strip consumable, comprising:
a web portion made from a metallic material; and
at least two bulge portions which are separated by at least a portion of said web portion,
wherein said at least two bulge portions contain a core material, and
wherein a thickness of said web portion is less than a thickness of said at least two bulge portions.

2. The strip consumable of claim 1, wherein said at least two bulge portions are positioned at opposite ends of said web portion.

3. The strip consumable of claim 1, wherein said core portions of each of said at least two bulge portions is surrounded by metallic material which is the same as the metallic material of said web portion.

4. The strip consumable of claim 1, wherein said web portion comprises a first half and a second half which are mated to each other to create said web portion.

5. The strip consumable of claim 1, wherein said consumable comprises additional bulge portions.

6. The strip consumable of claim 1, wherein said core portion in one of said bulge portions has a different chemistry from said core portion in the other or said bulge portions.

7. The strip consumable of claim 1, wherein said thickness of said bulge portions is in the range of 1.5 to 8 times the thickness of said web portion.

8. The strip consumable of claim 1, wherein said thickness of said bulge portions is in the range of 2 to 5 times the thickness of said web portion.

9. The strip consumable of claim 1, wherein a first of said at least one bulge portions has a different size than a second of said at least one bulge portions.

10. The strip consumable of claim 1, wherein at least a portion of said web portion extends outward from an outer edge of at least one of said bulge portions.

11. The strip consumable of claim 1, wherein said core portion in at least one of said bulge portions is a flux material.

12. A material deposition system; comprising:
a power supply which generates a deposition current; and
a consumable feeding system which feeds a metallic strip consumable and at least one cored consumable to a workpiece,
wherein said metallic strip consumable and said at least one cored consumable make contact with each other prior to said strip consumable and said at least one cored consumable contacting said workpiece, and
wherein said deposition current is shared by said metallic strip consumable and said at least one cored consumable.

13. The system of claim 12, wherein said at least one cored consumable is moved relative to said metallic strip consumable during deposition onto said workpiece, while said at least one cored consumable maintains contact with said metallic strip consumable.

14. The system of claim 12, wherein said consumable feeding system contains a contact tip and each of said metallic strip consumable and said at least one cored consumable are delivered to said workpiece with said contact tip.

15. The system of claim 12, wherein said at least one cored consumable has a flux core.

16. The system of claim 12, wherein said consumable feeding system delivers at least one additional cored consumable to said workpiece, where said at least one additional cored consumable shares said deposition current from said power supply.

17. The system of claim 12, where said at least one cored consumable makes contact with a longer side of said metallic strip consumable.

18. A material deposition system; comprising:
a power supply which generates a deposition current and provides said deposition current to a strip consumable prior to said strip consumable contacting a workpiece; and
a consumable feeding system which feeds said strip consumable to said workpiece, where said strip consumable comprises:
a web portion made from a metallic material; and
at least two bulge portions which are separated by at least a portion of said web portion,
wherein said at least two bulge portions contain a core material, and
wherein a thickness of said web portion is less than a thickness of said at least two bulge portions.

19. The system of claim 18, further comprising a pre-heat power supply which supplies a pre-heating current signal to said strip consumable prior to said strip consumable being delivered to said workpiece.

20. The system of claim 18, wherein said consumable feeding system contains a contact tip having a cavity through which said strip consumable passes, where said cavity has at least one protrusion portion which contacts at least some of said web portion to provide said deposition current to said strip consumable.
